(19) United States
(12) Patent Application Publication
(10) Pub. No.: US 2012/0264871 A1
(43) Pub. Date: Oct. 18, 2012

(54) Silicone-Based Impact Modifier Including a Graft Copolymer Having a Core-Shell Structure and Thermoplastic Resin Composition Including the Same

(75) Inventors: Hyung Rang Moon, Uiwang-si (KR); Ju Sung Kim, Uiwang-si (KR); Yun Kyu Lee, Uiwang-si (KR); Yu Ho Kim, Uiwang-si (KR); Il Jin Kim, Uiwang-si (KR); Kee Hae Kwon, Uiwang-si (KR); Han Su Lee, Uiwang-si (KR); Mi Sun Kim, Uiwang-si (KR); Ki Bo Chang, Uiwang-si (KR)

(73) Assignee: CHEIL INDUSTRIES INC., Gumi-si (KR)

(21) Appl. No.: 13/533,106

(22) Filed: Jun. 26, 2012

Related U.S. Application Data
(63) Continuation-in-part of application No. PCT/KR2010/006231, filed on Sep. 13, 2010.

(30) Foreign Application Priority Data
Dec. 30, 2009 (KR) 10-2009-0134758

(51) Int. Cl. C08G 77/445; C08L 69/00

(52) U.S. Cl. 524/537; 525/451

(57) ABSTRACT

A silicone-based impact modifier including a core-shell graft copolymer is disclosed. The silicone-based impact modifier includes a core made of a silicone-based rubber and alkyl acrylate and a shell made from an inorganic acrylate compound. Also disclosed is a thermoplastic resin composition including the silicone-based impact modifier.

### CROSS-REFERENCE TO RELATED APPLICATIONS

This application is a continuation-in-part of International Application No. PCT/KR2010/006231, filed Sep. 13, 2010, pending, which designates the U.S., published as WO 2011/081278, and is incorporated herein by reference in its entirety, and claims priority therefrom under 35 USC Section 120. This application also claims priority under 35 USC Section 119 from Korean Patent Application No. 10-2009-0134758, filed Dec. 30, 2009, in the Korean Intellectual Property Office, the entire disclosure of which is also incorporated herein by reference.

### FIELD OF THE INVENTION

The present invention relates to a silicone-based impact modifier comprising a graft copolymer having a core-shell structure and a thermoplastic resin composition including the same.

### BACKGROUND OF THE INVENTION

Impact modifiers are widely employed to provide or improve impact resistance of thermoplastic resins. Many impact modifiers include a thermoplastic resin having a core-shell structure, which aims to prevent aggregation of core particles formed of rubber particles and to improve compatibility of core particles and thermoplastic resins.

Impact modifiers can have a silicone-based rubber component as a core material. Unlike diene-based impact modifiers, silicone-based impact modifiers do not have a carbon-carbon double bond and thus can have an extremely low glass transition temperature. As a result, silicone-based impact modifiers can have superior thermal stability, chemical resistance and impact modifying effect at low temperatures. Methyl methacrylate copolymers and polystyrene acrylonitrile copolymers are examples of materials that have been used to form a shell of a silicone-based impact modifier.

When an impact modifier having a silicone-based rubber component as a core is added to resins with a high refractive index, such as polycarbonate, there can be a large difference between the refractive indexes of the base resin and the impact modifier. Also the rubber particle size can be several hundreds of nanometers. Thus goods manufactured using such compositions may become hazy or opaque, or can have poor coloring properties. Thus, there have been attempts to improve the refractive index of the impact modifier.

Korean Patent Publication No. 2007-0069703 discloses a method for improving refractive index of an impact modifier using rubber particles produced by cross-linking styrene-based aromatic compounds and alkyl acrylates in the presence of organosiloxane copolymer particles as a core, and using vinyl-based monomers and unsaturated carboxylic acids as a shell

Japanese Patent Publication No. 1998-017762 discloses the use of inorganic acrylic compounds having a high refractive index such as phenyl methacrylate and the like in a shell to improve refractive index

### SUMMARY OF THE INVENTION

The present invention provides a silicone-based impact modifier comprising a graft copolymer having a core-shell structure. The silicone-based impact modifier can have an improved refractive index and can provide superior exterior properties to a thermoplastic resin composition including the same.

The silicone-based impact modifier of the present invention includes a core comprising a silicone-based rubber and alkyl acrylate and a shell structure grafted onto the core comprising inorganic acrylic compounds

The weight ratio of the core to the shell can be about 50:50 to about 90:10.

The core can include about 10 to about 80% by weight of a silicone-based rubber and about 20 to about 90% by weight of alkyl acrylate.

The shell can include about 10 to about 100% by weight of inorganic acrylic compounds.

The graft copolymer can include the inorganic acrylic compound in an amount of about 10 to about 50% by weight, based on the total weight of the graft copolymer having the core-shell structure.

The silicone-based compound can include a cyclic organosiloxane. Examples of the silicone-based compound can include without limitation silicone-based rubbers produced by cross-linking hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, octaphenylcyclotetrasiloxane, and the like, and combinations thereof.

Examples of the alkyl acrylate can include without limitation methyl acrylate, ethyl acrylate, n-propyl acrylate, n-butyl acrylate, 2-ethylhexyl acrylate, hexylmetacrylate, 2-ethylhexylmetacrylate, and the like, and combinations thereof.

The inorganic acrylic-based compound includes an inorganic metal and an acrylic-based compound. Examples of the inorganic metal include without limitation zinc, zirconium, hafnium, titanium, yttrium, cerium, indium, potassium, aluminum, magnesium, calcium, and the like, and combinations thereof. Examples of the acrylic-based compound include without limitations acrylates, methacrylates, carboxylethyl acrylates, derivatives thereof, and the like, and combinations thereof.

The shell may include the inorganic acrylic-based compound and further include one or more other compounds. Examples of the other compounds include without limitation alkyl acrylates, alkyl methacrylates, aromatic vinyl compounds, aromatic vinyl-vinyl cyanide mixtures, and the like, and combinations thereof.

The graft copolymer having the core-shell structure according to the present invention can have a refractive index of about 1.410 to about 1.590.

Further, the present invention provides the thermoplastic resin comprising about 100 parts by weight of a thermoplastic resin (A) and about 1 to about 30 parts by weigh of the silicone-based impact modifier (B) according to the present invention.

Examples of the thermoplastic resin include without limitation polystyrene (PS) resins, acrylonitrile-butadiene-styrene copolymer (ABS) resins, rubber modified polystyrene (HIPS) resins, acrylonitrile-styrene copolymer (SAN) resins, methyl methacrylate-butadiene-styrene copolymer (MBS) resins, acrylonitrile-ethylacrylate-styrene copolymer (AES) resins, polycarbonate (PC) resins, polyphenylene ether (PPE) resins, polyolefin resins such as polyethylene (PE) resins and polypropylene (PP) resins, polyester resins such as polyethylene terephthalate (PET) resins and polybutylene terephthalate (PBT) resins, polyvinylchloride (PVC) resins, polymethylmethacrylate (PMMA) resins, polyamide (PA)-based resins, and the like, and combinations thereof.

The thermoplastic resin according to the present invention may further include about 0.1 to about 50 parts by weight of one or more additives. Examples of the additives include without limitation flame-retardants, lubricants, antibiotics, mold release agents, nucleating agents, plasticizers, thermal stabilizers, antioxidants, light stabilizers, compatibilizing agents, pigments, dyes, inorganic additives, and the like, and combinations thereof.

Further, the present invention provides a plastic article manufactured from the thermoplastic resin composition according to the present invention.

Hereinafter, the present invention will be described in detail.

### DETAILED DESCRIPTION OF THE INVENTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

The present invention provides a silicone-based impact modifier comprising a graft copolymer having a core-shell structure, wherein the core comprises a silicone-based rubber and alkyl acrylate and the shell comprises an inorganic acrylic-based compound.

The refractive index of the silicone-based impact modifier according to the present invention can be improved by introducing an inorganic acrylic-based compound into a shell of a graft polymer.

When there is a large difference between the refractive indexes of an impact modifier and a base resin, goods manufactured using the same may become opaque or hazy and the coloring of the same can be poor. However, these problems can be improved remarkably when the silicone-based impact modifier according to the present invention is added to a resin since the refractive index difference between the silicone-based impact modifier and a base resin can be small. Further, the existing properties of a base resin may be kept intact since the silicone-based impact modifier according to the present invention can have superior compatibility with a base resin.

In the present invention, the core-shell graft copolymer can include a weight ratio of the core of the graft copolymer to the shell of about 50:50 to about 90:10.

In some embodiments, the core-shell graft copolymer can include the core in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90% by weight. Further, according to some embodiments of the present invention, the amount of core can be in a range from about any of the foregoing amounts to about any other of the foregoing amounts.

In some embodiments, the core-shell graft copolymer can include the shell in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% by weight. Further, according to some embodiments of the present invention, the amount of shell can be in a range from about any of the foregoing amounts to about any other of the foregoing amounts.

If the amount of the core component is less than an amount within the above range, the effect of impact modification may decline due to reduced rubber content. In contrast, if the amount of the core component is more than an amount within the above range, rubber particles may aggregate together due to the reduced amount of the shell, and impact strength and refractive index may decline due to reduced compatibility with a resin.

The silicone-based rubber is included in a core. The core may be produced using a cyclosiloxane (or cyclic organosiloxane) compound. Examples of the cyclosiloxane compound may include without limitation hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, octaphenylcyclotetrasiloxane, and the like. One or more siloxanes among the siloxanes may be selected and used to manufacture a silicone-based rubber.

Examples of the alkyl acrylate included in a core may include without limitation methyl acrylate, ethyl acrylate, n-propyl acrylate, n-butyl acrylate, 2-ethylhexyl acrylate, hexylmethacrylate, 2-ethylhexylmethacrylate, and the like, and combinations thereof. In exemplary embodiments, the alkyl acrylate is n-buthyl acrylate.

The core includes a rubber component which may be produced by polymerizing the silicone-based rubber, the alkyl acrylate and a cross-linking agent.

Examples of the cross-linking agent may include without limitation allyl methacrylate, triallyl cyanurate, triallyl isocyanurate, divinylbenzene and the like, and combinations thereof, and may be utilized as a cross-linking agent to polymerize the alkyl acrylate. In exemplary embodiments, the cross-linking agent may include allyl methacrylate or triallyl isocyanurate (which can have superior thermal stability). The cross-linking agent of the present invention can be used in an amount of about 0.01 to about 10 parts by weight based on the total weight of reactants of the core, for example about 0.01 to about 5 parts by weight.

The core of the silicone-based impact modifier according to the present invention can include about 10 to about 80% by weight of a silicone-based rubber and about 20 to about 90% by weight of alkyl acrylate.

In some embodiments, the core of the silicone-based impact modifier can include the silicone-based rubber in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80% by weight. Further, according to some embodiments of the present invention, the amount of silicone-based rubber can be in a range from about any of the foregoing amounts to about any other of the foregoing amounts.

In some embodiments, the core of the silicone-based impact modifier can include the alkyl acrylate in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90% by weight. Further, according to some embodiments of the present invention, the amount of alkyl acrylate can be in a range from about any of the foregoing amounts to about any other of the foregoing amounts.

If the amount of the silicone-based rubber is less than an amount within the above range, the impact modifying effect may be decreased dramatically at low temperatures. If the amount of the silicone-based rubber is more than an amount within the above range, the refractive index of the whole impact modifier can be lowered, which can reduce coloring property when it is added to a resin and the cost of production may also be increased.

Further, grafting efficiency of a shell may be decreased if the amount of the alkyl acrylate is less than an amount within the above range. If the amount of the alkyl acrylate is more than an amount within the above range, the amount of the silicone-based rubber can be lowered relatively, and the impact modifying effect at low temperatures can be decreased, rubber particles can aggregate due to the lowered amount of a shell, impact modifying effect may be reduced due to lowered compatibility, and refractive index may also be lowered.

The average particle diameter of the core can be about 0.05 to about 1 μm, which can help maintain a balance of impact resistance and coloring property.

A monomer forming the shell on the core is graft-polymerized and forms the graft copolymer of the core-shell structure. The shell may be formed by an inorganic acrylic-based compound or by the combination of one or more inorganic acrylic-based compounds and/or other monomers graft-polymerized with the core. Examples of other monomers forming the shell may include without limitation acrylic-based monomers, vinyl-based monomers, and the like, and combinations thereof. In the present invention, the refractive index of the shell can be improved by using inorganic compounds as compounds forming the shell

In another embodiment of the present invention, the shell may be graft-polymerized by adding inorganic acrylic-based compounds and optionally other compounds to adjust the polymerization reaction and the refractive index to appropriate levels. Examples of the other compounds that can be added in this step include without limitation of alkyl acrylates, alkyl methacrylates, aromatic vinyl compounds, aromatic vinyl-vinyl cyanide mixtures, and the like, and combinations thereof.

Examples of alkyl acrylates and alkyl methacrylates include without limitation C1-C10 alkyl acrylates and C1-C10 alkyl methacrylates, such as methyl(meth)acrylate, ethyl(meth)acrylate, and butyl(meth)acrylate, and the like, and combinations thereof. Examples of aromatic vinyl compounds include without limitation styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene and the like, and combinations thereof. Examples of vinyl cyanide compounds include without limitation acrylonitrile, ethacrylonitrile, methacrylonitrile, and the like, and combinations thereof.

The inorganic acrylic-based compound of the shell may comprise inorganic metals and acrylic-based compounds. Examples of the inorganic metals may include without limitation zinc, zirconium, hafnium, titanium, yttrium, cerium, indium, potassium, aluminum, magnesium, calcium, and the like, and combinations thereof. Examples of the acrylic-based compounds may include without limitation acrylates, methacrylates, carboxylethylacrylates, derivatives thereof, and the like, and combinations thereof. In exemplary embodiments, the inorganic metal can have a high refractive index, such as zinc, zirconium, hafnium or titanium.

Examples of the inorganic acrylic-based compound include without limitation zinc acrylate, zinc methacrylate, zirconium acrylate, zirconium methacrylate, titanium acrylate, titanium methacrylate, zirconium carboxyethyl acrylate, hafnium carboxyethyl acrylate, zirconium bromoenol lactone carboxylate, triacrylate and the like, and mixtures thereof.

The shell can include about 10 to about 100% by weight of the inorganic acrylic-based compound. In some embodiments, the shell can include can include the inorganic acrylic-based compound in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100% by weight. Further, according to some embodiments of the present invention, the amount of the inorganic acrylic-based compound in the shell can be in a range from about any of the foregoing amounts to about any other of the foregoing amounts.

If the amount of the inorganic acrylic-based compound is less than about 10% by weight of the shell, the refractive index may be less than required.

The graft copolymer comprising the core-shell structure can include about 10 to about 50% by weight of the inorganic acrylic-based compounds, based on the total weight of the graft copolymer. In some embodiments, the graft copolymer can include can include the inorganic acrylic-based compound in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% by weight. Further, according to some embodiments of the present invention, the amount of the inorganic acrylic-based compound in the graft copolymer can be in a range from about any of the foregoing amounts to about any other of the foregoing amounts.

If the amount of the inorganic acrylic-based compounds is less than about 10% of a total weight of the graft copolymer, the refractive index of the impact modifier may be lowered.

The silicone-based impact modifier formed by the above description according to the present invention can have a refractive index of about 1.410 to about 1.590.

Methods of making the silicone-based impact modifier according to the present invention are not limited and the silicone-based impact modifier can be manufactured according to the methods known to those skilled in the art such as emulsion polymerization. Hereinafter, an exemplary embodiment of a manufacturing method will be described.

First, a silicone latex including a rubber core can be prepared in a dispersed aqueous solution using emulsifiers. Examples of the emulsifiers include without limitation anionic emulsifiers such as sodium, ammonium, and potassium salts, and the like, and combinations thereof, such as alkyl sulfates having 4 to 30 carbons. Examples of alkyl sulfates include without limitation sodium dodecylsulfate, sodium dodecylbenzensulfonate, and the like, and combinations thereof. In exemplary embodiments, the emulsifier can be sodium dodecylbenzensulfonate, which is available in a broad pH range. The emulsifiers can be used in an amount of about 0.1 to about 5 parts by weight based on the total amount or weight of reactants, for example about 0.1 to about 2 parts by weight based on the total weight of reactants.

Under a stream of nitrogen, alkyl acrylate and cross-linking agents are mixed and added into the silicone latex. The mixture is heated to a temperature of about 50 to about 100° C.

Then, a plastic shell is manufactured by copolymerizing acrylic-based and/or vinyl-based monomers comprising inorganic compounds with a polymerization initiator.

An example of the polymerization initiator is a free radical initiator that generates free radicals by thermal decomposition or oxidation-reduction reaction. Examples of the polymerization initiator include without limitation potassium persulfate, magnesium persulfate, benzoyl peroxide, hydrogen peroxide, dibenzoyl peroxide, cumene hydroperoxide, tert-butyl hydroperoxide, diisopropylbenzene, hydroperoxide and the like, and combinations thereof. The polymerization initiator may be utilized in an amount of about 0.01 to about 5 parts, for example about 0.1 to about 2 parts, by weight based on the total amount or weight of the reactants of the shell.

The graft copolymerization is progressed by adding mixtures of acrylic-based and/or vinyl-based monomers comprising copolymerization initiators and inorganic acrylic-based compounds into a latex including rubber particles at a constant speed at a temperature of about 50 to about 100° C. If necessary, cross-linking agents may be added and mixed. Examples of the cross-linking agents include without limitation allyl methacrylate, triallylcyanurate, triallyl isocyanulate, divinylbenzene and the like, and combinations thereof.

The silicone-based impact modifier can be obtained using coagulants in accordance with conventional coagulation, filtration and drying steps. The coagulant can be a metallic salt. Examples of the metallic salts include without limitation magnesium chloride, calcium chloride, magnesium sulfate, aluminum sulfate and the like, and combinations thereof.

Further, the present invention provides a composition including (A) about 100 parts by weight of a thermoplastic resin and (B) about 1 to about 30 parts by weight of the silicone-based impact modifier comprising the graft copolymer having the core shell structure according to the present invention (wherein the amount of silicone-based impact modifier (B) is based on about 100 parts by weight of the thermoplastic resin (A)). In some embodiments, the composition may include the silicone-based impact modifier in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the silicone-based impact modifier can be in a range from about any of the foregoing amounts to about any other of the foregoing amounts.

Examples of the thermoplastic resin include without limitation polystyrene (PS) resins, acrylonitrile-butadiene-styrene copolymer (ABS) resins, rubber modified polystyrene (HIPS) resins, acrylonitrile-styrene-acrylate copolymer (ASA) resins, acrylonitrile-styrene copolymer (SAN) resins, methylmethacrylate-butadiene-styrene (MBS) copolymer resins, acrylonitrile-ethylacrylate-styrene (AES) copolymer resins, polycarbonate (PC) resins, polyphenylene ether (PPE) resins, polyolefin resins such as polyethylene (PE) resins and polypropylene (PP) resins, polyester resins such as polyethylene terephthalate (PET) resins and polybutylene terephthalate (PBT) resins, polyvinylchloride (PVC) resins, polymethylmethacrylate (PMMA) resins, polyamide (PA)-based resins, and the like, and combinations thereof.

In exemplary embodiments, the thermoplastic resin (A) can be a polycarbonate (PC) resin since the silicone-based impact modifier (B) comprising the graft copolymer having a core-shell structure according to the present invention has a high refractive index and accordingly the difference between the refractive index of the base resin and the impact modifier can be reduced.

The thermoplastic resin composition according to the present invention may further comprise about 0.1 to about 50 parts by weight of one or more additives, based on about 100 parts by weight of the thermoplastic resin (A). Examples of the additives may include without limitation flame-retardants, lubricants, antibiotics, mold release agents, nucleating agents, plasticizers, thermal stabilizers, antioxidants, light stabilizers, compatibilizing agents, pigments, dyes, inorganic addictives and the like and combinations thereof.

Further, the present invention provides a plastic article manufactured from the thermoplastic resin composition according to the present invention. The plastic article can be produced using molding techniques known in the art.

### Examples

### Example 1A

### Manufacture of Impact Modifier Powder

90 g of a cross-linked dimethylsiloxane copolymer having a refractive index of 1.429, a particle size of 220 nm, and 65% toluene-insoluble, and 3.4 g of sodium dodecyl benzene sulfate are mixed in water with 92.9 parts by weight of a silicone latex dispersed in 970 g of distilled water, 5 parts by weight of butyl acrylate, a cross-linking agent triallyl isocyanurate and an initiator diisopropylbenzene hydroperoxide. Then, ethylenediaminetetraacetic acid, disodium salt (EDTA•2Na, YASUDA Chemicals Co., Ltd.), ferrous sulfate (SaeHan PNG, Ltd.) and sodium formaldehyde sulfoxylate (Korea Kett Engineering, Ltd) which act as catalysts are added and the mixture is polymerized at 60° C. to form a core. Next, 2.1 parts by weight of zinc methacrylate (Aldrich) and an initiator diisopropylvenxene hydroperoxide are added together and a shell is formed by graft-polymerizing the same. Finally, the core-shell graft copolymer is condensed in 1% aqueous solution of magnesium sulfate and then, impact modifier powder is obtained by washing and drying.

### Comparative Example 1A

### Manufacture of Impact Modifier Powder

The same procedure as used in Example 1A is used, except that 2.1 parts by weight of methyl methacrylate instead of zinc methacrylate (Aldrich) is used as a monomer to form the shell of the core-shell graft copolymer.

The refractive indexes of the silicone-based impact modifier particles manufactured from Example 1A and Comparative Example 1A are evaluated using a Refractometer (Metricon 2010) after compressing the powder and the results are shown in Table 1 below.

TABLE 1

| | Example 1A | Comparative Example 1A |
|---|---|---|
| Refractive Index | 1.455 | 1.414 |

### Example 2A

### Thermoplastic Resin Composition

4% by weight of the impact modifier powder manufactured according to Example 1A and 1% by weight of carbon black are added to 95% of by weight of a polycarbonate resin (CHEIL INDUSTRIES INC., INFINO EH-1050). The composition is processed at 260° C. to form a specimen.

### Comparative Example 2A

### Thermoplastic Resin Composition

A thermoplastic resin composition is produced using the same process of Example 2A except that the impact modifier powder manufactured according to Comparative Example 1A is used instead of the impact modifier powder manufactured according to Example 1A.

The physical properties of the thermoplastic resins manufactured from Example 2A and Comparative Example 2A are evaluated using following methods and the results are described in Table 2 below.
(1) Izod impact strength is evaluated using the ASTM D-256 method. The unit is kgf.cm/cm.
(2) Coloring property of a resin: Black Index (BI): In the step of resin processing, 1 w % carbon black is added and then, expression levels of black color are quantified. A high number represents black and a low number represents white. In the other words, higher BI numbers represent a deeper black color specimen (and better coloring properties) and lower BI numbers represent a white or opaque specimen (and poorer coloring properties). BI is evaluated with a colorimeter Konica-Minolta CM3600.

TABLE 2

| | | | Comparative |
|---|---|---|---|
| | | Example 2A | Example 2A |
| Izod | ¼″ | 57.2 | 59.3 |
| | ⅛″ | 78.1 | 75.5 |
| Coloring properties | Eye test* | Good | Normal |
| | Black Index** | 16.1 | 9.5 |

Eye test*: Relatively compared

As shown in Tables 1 and 2, the impact strength of the impact modifier having a refractive index of 1.455 of Example 2A and the impact modifier having a refractive index of 1.414 of Comparative Example 2A are similar. However, the coloring property of Example 2A is superior to that of Comparative Example 2A. The result shows that the silicone-based impact modifier according to the present invention can maintain superior impact strength and can improve coloring property when added into a resin.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A silicone-based impact modifier comprising a graft copolymer having a core-shell structure comprising:
a core comprising a silicone-based rubber and alkyl acrylate; and
a shell comprising an inorganic acrylic-based compound.

2. The silicone-based impact modifier of claim 1, wherein the weight ratio of said core to said shell is about 50:50 to about 90:10.

3. The silicone-based impact modifier of claim 1, wherein said core comprises about 10 to about 80% by weight of the silicone-based rubber and about 20 to about 90% by weight of the alkyl acrylate.

4. The silicone-based impact modifier of claim 1, wherein said shell comprises about 10 to about 100% by weight of the inorganic acrylic-based compound.

5. The silicone-based impact modifier of claim 1, wherein said graft copolymer having the core-shell structure comprises about 10 to about 50% by weight of the inorganic acrylic-based compound.

6. The silicone-based impact modifier of claim 1, wherein said silicone-based rubber comprises hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, octaphenylcyclotetrasiloxane, or a combination thereof.

7. The silicone-based impact modifier of claim 1, wherein said alkyl acrylate comprises methyl acrylate, ethyl acrylate, n-propyl acrylate, n-butyl acrylate, 2-ethylhexyl acrylate, hexylmethacrylate, 2-ethylhexylmethacrylate, or a combination thereof.

8. The silicone-based impact modifier of claim 1, wherein said inorganic acrylic-based compound comprises an inorganic metal and an acrylic-based compound, wherein the inorganic metal comprises zinc, zirconium, hafnium, titanium, yttrium, cerium, indium, potassium, aluminum, magnesium, calcium, or a combination thereof, and wherein the acrylic-based compound comprises acrylate, methacrylate, carboxylethylacrylate, a derivative thereof, or a combination thereof.

9. The silicone-based impact modifier of claim 1, wherein said inorganic acrylic-based compound comprises zinc acrylate, zinc methacrylate, zirconium acrylate, zirconium methacrylate, titanium acrylate, titanium methacrylate, zirconium carboxyethyl acrylate, hafnium carboxyethyl acrylate, zirconium bromoenol lactone carboxylate, or a combination thereof.

10. The silicone-based impact modifier of claim 1, wherein said shell further comprises one or more monomers comprising an alkyl acrylate, alkyl methacrylate, aromatic vinyl compound, aromatic vinyl-vinyl cyanide mixture, or a combination thereof.

11. The silicone-based impact modifier of claim 1, wherein the refractive index of said impact modifier is about 1.410 to about 1.590.

12. A thermoplastic resin composition comprising:
(A) about 100 parts by weigh of a thermoplastic resin; and
(B) about 1 to about 30 parts by weight of a silicone-based impact modifier comprising a graft copolymer having a core-shell structure, wherein the core comprises a silicone-based rubber and alkyl acrylate and the shell comprises an inorganic acrylic-based compound.

13. The thermoplastic resin composition of claim 12, wherein said thermoplastic resin comprises a polystyrene (PS) resin, an acrylonitrile-butadiene-styrene copolymer (ABS) resin, a rubber modified polystyrene (HIPS) resin, an acrylonitrile-styrene-acrylate (ASA) copolymer resin, an acrylonitrile-styrene copolymer (SAN) resin, a methylmethacrylate-butadiene-styrene (MBS) copolymer resin, an acrylonitrile-ethylacrylate-styrene (AES) copolymer resin, a polycarbonate (PC) resin, a polyphenylene ether (PPE) resin, a polyethylene (PE) resin, a polypropylene (PP) resin, a polyethylene terephthalate (PET) resin, a polybutylene terephthalate (PBT) resin, a polyvinylchloride (PVC), a polymethylmethacrylate (PMMA) resin, a polyamide (PA)-based resin, or a combination thereof.

14. The thermoplastic resin composition of claim 12, wherein said composition further comprises about 0.1 to about 50 parts by weight of one or more additives selected from the group consisting of flame-retardants, lubricants, antibiotics, mold release agents, nucleating agents, plasticizers, thermal stabilizers, antioxidants, light stabilizers, compatibilizing agents, pigments, dyes, inorganic addictives, and combinations thereof.

15. A plastic article manufactured from said thermoplastic resin composition of claim 12.
